(19) United States
(12) Patent Application Publication
(10) Pub. No.: US 2025/0028545 A1
(43) Pub. Date: Jan. 23, 2025

(54) METHOD FOR GENERATING DASHBOARD FOR VISUALIZING DATA STREAMS AND APPARATUS, COMPUTER DEVICE, AND STORAGE MEDIUM

(71) Applicant: TENCENT TECHNOLOGY (SHENZHEN) COMPANY LIMITED, Shenzhen (CN)

(72) Inventors: Zhenhong ZHANG, Shenzhen (CN); Jinkun HOU, Shenzhen (CN); Runzeng GUO, Shenzhen (CN); Shaoming WANG, Shenzhen (CN); Jinming ZHANG, Shenzhen (CN)

(21) Appl. No.: 18/904,876

(22) Filed: Oct. 2, 2024

Related U.S. Application Data
(63) Continuation of application No. PCT/CN2023/101108, filed on Jun. 19, 2023.

(30) Foreign Application Priority Data
Aug. 22, 2022 (CN) 202211004210.9

(51) Int. Cl. G06F 9/451

(52) U.S. Cl. CPC G06F 9/451

(57) ABSTRACT

A method for generating a dashboard for visualizing data streams is applicable to the fields of cloud computing and intelligent transportation. The method includes acquiring a domain model diagram of a service system and at least two data sources; determining relationship data among all domain entities in the domain model diagram based on a first representation vector of the domain model diagram; determining a data source entity relationship, a data stream relationship, and impact factors of the at least two data sources based on the relationship data and the at least two data sources; and generating a dashboard for visualizing data streams of the service system based on the data source entity relationship, the data stream relationship, and the impact factors.

### RELATED APPLICATIONS

This application is a continuation of PCT Patent Application No. PCT/CN2023/101108, filed on Jun. 19, 2023, which claims priority to Chinese Patent Application No. 2022110042109, filed with the China National Intellectual Property Administration on Aug. 22, 2022, and entitled “METHOD FOR GENERATING A DASHBOARD FOR VISUALIZING DATA STREAMS AND APPARATUS, COMPUTER DEVICE, AND STORAGE MEDIUM”. The two applications are both incorporated by reference in their entirety.

### FIELD OF THE TECHNOLOGY

This application relates to the field of computer technologies, and in particular, to a method for generating a dashboard for visualizing data streams and apparatus, a computer device, a storage medium, and a computer program product.

### BACKGROUND OF THE DISCLOSURE

With development of computer technologies and Internet technologies, a data dashboard is a very important way in visual data management. As such a data dashboard design attracts much interest. The data dashboard can intuitively reflect a service change and help decision-makers make service adjustments and decisions.

However, a developer is usually required to configure a data source entity. That is, a data dashboard is specified based on a product or service requirement. The developer manually specifies two or more dimensions based on experience, and then creates data dashboards with different dimensions. Since it is necessary to manually configure the data source entity, a relationship of the data source entity is often ignored, and there may be redundant logic and high data collection overhead. Therefore, such a process can cause poor quality of the finally generated data stream dashboard.

### SUMMARY

According to embodiments disclosed in this application, a method for generating a dashboard for visualizing data streams and apparatus, a computer device, a computer-readable storage medium, and a computer program product are provided.

One aspect of this application provides a method for generating a dashboard for visualizing data streams. The method is performed by a computer device and includes acquiring a domain model diagram of a service system and at least two data sources; determining relationship data among all domain entities in the domain model diagram based on a first representation vector of the domain model diagram; determining a data source entity relationship, a data stream relationship, and impact factors of the at least two data sources based on the relationship data and the at least two data sources; and generating a dashboard for visualizing data streams of the service system based on the data source entity relationship, the data stream relationship, and the impact factors.

Another aspect of this application further provides a computer device. The computer device includes a memory and one or more processors, the memory has computer-readable instructions stored therein, and the processor, when executing the computer-readable instructions, implements the following operations: acquiring a domain model diagram of a service system and at least two data sources; determining relationship data among all domain entities in the domain model diagram based on a first representation vector of the domain model diagram; determining a data source entity relationship, a data stream relationship, and impact factors of the at least two data sources based on the relationship data and the at least two data sources; and generating a dashboard for visualizing data streams of the service system based on the data source entity relationship, the data stream relationship, and the impact factors.

Another aspect of this application further provides a non-transitory computer-readable storage medium. The computer-readable storage medium has computer-readable instructions stored thereon, and the computer-readable instructions, when executed by a processor, implements the following operations: acquiring a domain model diagram of a service system and at least two data sources; determining relationship data among all domain entities in the domain model diagram based on a first representation vector of the domain model diagram; determining a data source entity relationship, a data stream relationship, and impact factors of the at least two data sources based on the relationship data and the at least two data sources; and generating a dashboard for visualizing data streams of the service system based on the data source entity relationship, the data stream relationship, and the impact factors.

Details of one or more embodiments of this application are provided in the accompanying drawings and descriptions below. Other features and advantages of this application become apparent from the specification, the accompanying drawings, and the claims.

### BRIEF DESCRIPTION OF THE DRAWINGS

To describe the technical solutions of embodiments of this application more clearly, the following briefly introduces the accompanying drawings required for describing embodiments and exemplary technical descriptions. Apparently, the accompanying drawings in the following description show only some embodiments of this application, and a person of ordinary skill in the art may still derive other drawings from these accompanying drawings without creative efforts.

FIG. 1 is an application environment diagram of a method for generating a dashboard for visualizing data streams consistent with one embodiment of the present disclosure.

FIG. 2 is a schematic flowchart of a method for generating a dashboard for visualizing data streams consistent with an embodiment of the present disclosure.

FIG. 3 is a schematic diagram of a domain model consistent with an embodiment of the present disclosure.

FIG. 4 is a schematic diagram of another domain model consistent with an embodiment of the present disclosure.

FIG. 5 is a schematic diagram in which a deep neural network model processes input data of an input layer consistent with an embodiment of the present disclosure.

FIG. 6 is a schematic flowchart of operations of configuring a relationship between different aggregated vector data to acquire a relationship data sample consistent with an embodiment of the present disclosure.

FIG. 7 is a schematic diagram of an overall architecture of a high-quality data stream dashboard method based on deep learning and a domain model consistent with an embodiment of the present disclosure.

FIG. 8 is a domain model diagram of a data source entity of a palm-scan system consistent with an embodiment of the present disclosure.

FIG. 9 is a schematic diagram of a structure of a multi-layer neural network for a subway transportation service scenario consistent with an embodiment of the present disclosure.

FIG. 10 is a schematic diagram of deep learning parameter adjusting processing consistent with an embodiment of the present disclosure.

FIG. 11 is a block diagram of a structure of a apparatus for generating a dashboard for visualizing data streams consistent with an embodiment of the present disclosure.

FIG. 12 is a diagram of an internal structure of a computer device consistent with an embodiment of the present disclosure.

### DESCRIPTION OF EMBODIMENTS

To make the objectives, technical solutions, and advantages of this application clearer, the following further describes this application in detail with reference to the accompanying drawings and embodiments. The specific embodiments described herein are only used for explaining this application, and are not used for limiting this application.

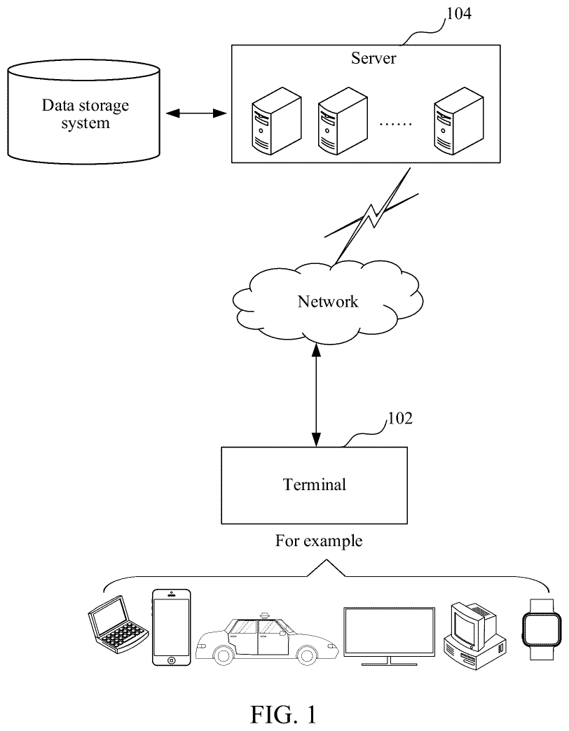

A method for generating a dashboard for visualizing data streams provided in embodiments of this application may be applied to an application environment shown in FIG. 1. A terminal 102 communicates with a server 104 over a network. A data storage system may store data that needs to be processed by the server 104. The data storage system may be integrated in the server 104, or placed on a cloud or another server. The server 104 may acquire a domain model diagram of a service system and at least two data sources locally. The server 104 may alternatively acquire, from the terminal 102, a domain model diagram of a service system and at least two data sources. Further, the server 104 may determine relationship data among all domain entities in the domain model diagram based on a first representation vector of the domain model diagram, and determine a data source entity relationship and data stream relationship between the at least two data sources and impact factors of the at least two data sources based on the relationship data and the at least two data sources. The server 104 may generate a dashboard for visualizing data streams of the service system based on the data source entity relationship, the data stream relationship, and the impact factors.

The terminal 102 may be but is not limited to a variety of desktop computers, notebook computers, smart phones, tablets, Internet of Things devices, and portable wearable devices. The Internet of things devices may be smart speakers, smart televisions, smart air conditioners, smart vehicle-mounted devices, or the like. The portable wearable devices may be smart watches, smart bands, head-mounted devices, or the like.

The server 104 may be implemented by using an independent server or a server cluster that includes a plurality of servers. The server 104 provided in embodiments of this application may alternatively be a service node in a blockchain system. A peer to peer (P2P) network is formed between each service node in the blockchain system. A P2P protocol is an application layer protocol that runs over a transmission control protocol (TCP).

A cloud technology refers to a hosting technology that integrates resources, such as hardware, software, and a network within a wide area network or local area network to implement data computing, storage, processing, and sharing.

The cloud technology is a general term of a network technology, an information technology, an integration technology, a management platform technology, and an application technology based on a cloud computing business model application, and may form a resource pool to satisfy what is needed in a flexible and convenient manner. A cloud computing technology may be the backbone. A lot of computing resources and storage resources are needed for background services in a technical network system, such as video websites, picture websites, and more portal websites. With advanced development and application of the Internet industry, all objects are likely to have their own recognition flags in the future. These flags need to be transmitted to a background system for logical processing. Data at different levels is to be processed separately. Therefore, data processing in all industries requires support of a powerful system, and is implemented only through cloud computing.

Big data refers to a collection of data that cannot be captured, managed, and processed by using conventional software tools within a specific time range. Big data is a massive, high-growth, and diverse information asset that needs a new processing mode to have stronger decision-making power, insight discovery, and process optimization capabilities. With the advent of the cloud era, big data has also attracted more attention. For big data, it is necessary to have a special technology to effectively process a large amount of data within a tolerable elapsed time. Technologies applicable to big data include massively parallel processing databases, data mining, distributed file systems, distributed databases, cloud computing platforms, the Internet, and scalable storage systems.

Artificial intelligence (AI) is a theory, a method, a technology, and an application system that use a digital computer or a machine controlled by the digital computer to simulate, extend, and expand human intelligence, perceive an environment, acquire knowledge, and use knowledge to acquire a desirable result. In other words, the artificial intelligence is a comprehensive technology in computer science and attempts to understand the essence of intelligence and produce a new intelligent machine that can react in a manner similar to human intelligence. The artificial intelligence is to study the design principles and implementation methods of various intelligent machines, to enable the machines to have the functions of perception, reasoning, and decision-making.

The artificial intelligence technology is a comprehensive discipline, and relates to a wide range of fields including both hardware-level technologies and software-level technologies. The basic artificial intelligence technologies generally include technologies such as a sensor, a dedicated artificial intelligence chip, cloud computing, distributed storage, a big data processing technology, an operating/interaction system, and electromechanical integration. An artificial intelligence software technology mainly includes some major directions such as a computer vision technology, a speech processing technology, a natural language processing technology, and machine learning/deep learning, automated driving, and smart transportation.

A computer vision (CV) technology is a science that studies how to use a machine to “see”, and the computer vision further refers to use a camera and a computer instead of human eyes to implement machine vision, such as recognition and measurement of a target, and further perform graphic processing, so that the computer processes the target into an image more suitable for human eyes to observe, or an image transmitted to an instrument for detection. As a scientific discipline, the computer vision studies related theories and technologies, and attempts to establish an artificial intelligence system that can acquire information from images or multidimensional data. The computer vision technology generally includes technologies such as image processing, image recognition, image semantic understanding, image retrieval, OCR, video processing, video semantic understanding, video content/behavior recognition, three-dimensional object reconstruction, a 3D technology, virtual reality, augmented reality, synchronous positioning and map construction, autonomous driving, and smart transportation, and further include biological feature recognition technologies such as common face recognition and fingerprint recognition.

Machine learning (ML) is a multi-field interdiscipline that relates to a plurality of disciplines such as the probability theory, statistics, the approximation theory, convex analysis, and the algorithm complexity theory. The machine learning specializes in studying how a computer simulates or implements a human learning behavior to acquire new knowledge or skills, and reorganize an existing knowledge structure, to keep improving own performance. The machine learning is the core of the artificial intelligence, is a basic way to make the computer intelligent, and is applied to various fields of artificial intelligence. The machine learning and deep learning generally include technologies such as an artificial neural network, a belief network, reinforcement learning, transfer learning, inductive learning, and learning from demonstrations.

The deep learning is a branch of machine learning and an algorithm that attempts to perform high-level abstraction on data by using a plurality of processing layers including complex structures or composed of a plurality of nonlinear transformations. The deep learning is an algorithm in machine learning based on representation learning on data. There are a plurality of deep learning frameworks, such as a convolutional neural network, a deep belief network, and a recurrent neural network, which have been applied in fields such as computer vision, speech recognition, natural language processing, audio recognition, and bioinformatics and have achieved excellent results.

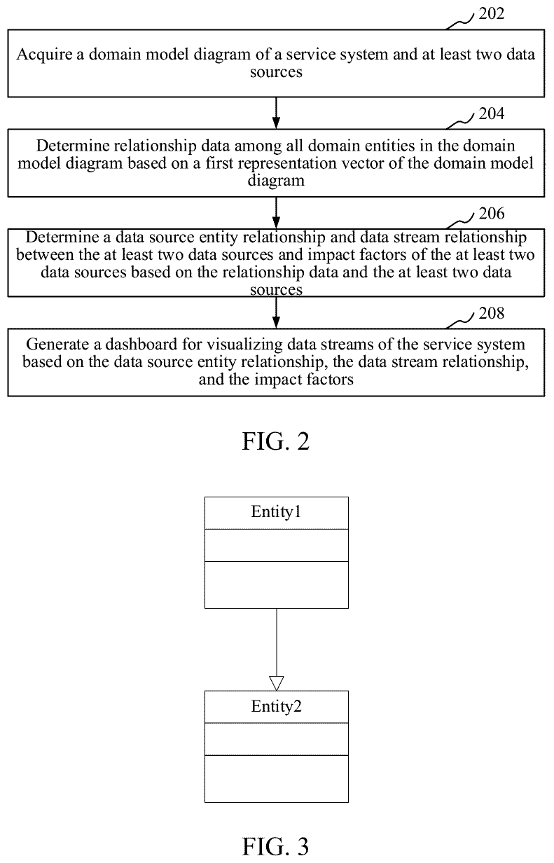

In one embodiment, as shown in FIG. 2, a method for generating a dashboard for visualizing data streams is provided. An example in which the method is applied to the server in FIG. 1 is used, including the following operations:

Operation 202: Acquire a domain model diagram of a service system and at least two data sources.

The service system may include different service systems. Different service systems may correspond to different services or functions. For example, the service system may include a system or platform for online shopping, or a system for managing a subway transportation network, a payment system, and the like.

A domain model is a visual representation of a concept within a domain or an object in the real world, also referred to as conceptual model, domain object model, and analysis object model. The domain model focuses on analyzing a domain of a problem, discovering an important service domain concept, and establishing a relationship between service domain concepts. For example, the domain model in this application may be a model representing a concept in a domain in a domain-driven design. In other words, the domain model includes a class diagram, a sequence diagram, and the like.

The domain model diagram is a model diagram representing a concept in a domain. The domain model diagram in this application may be a class diagram, a sequence diagram, and the like of a domain model acquired based on unified modeling language (UML). For example, the domain model diagram in this application is a UML diagram. UML, also referred to as standard modeling language, is a language used for visual modeling of a software-intensive system. A definition of UML includes two elements: UML semantics and UML notation. Unified modeling language (UML) is a type of modeling language, and models are mostly represented in diagrams.

An entity represents a discrete object. The entity may be considered (roughly) as a term, such as a computer, an employee, a song, or a mathematical theorem. A relationship describes how two or more entities are related to each other.

A data source refers to an object generating data in a service. The data source in this application refers to a data source entity. The data source in this application may also be referred to as the data source entity. The data source entity in the service system in this application may include a plurality of different data source entities. For example, a car generates data of car price, and the car also generates data of car quality. In this case, the entity and the data source entity are both the car, and the car price and the car quality are data generated by the entity of the car.

Specifically, the server may acquire domain model diagrams corresponding to different service systems from a local database, and the server may further directly acquire a plurality of data source entities in a specific service system from the local database simultaneously.

For example, an example of a service system for a subway transportation scenario is used for description. A palm-scan system is a system acquiring identity authentication based on palm prints to acquire corresponding permission bound to identity to perform various tasks. This system may serve a large quantity of service systems. For a large amount of data continuously generated in the subway transportation scenario, a dashboard for visualizing data streams needs to be established at a service management and control level for real-time management and control. The service system for the subway transportation scenario can use the palm-scan system to monitor data stream of passengers taking the subway in different periods. In service development, a developer needs to monitor a large amount of data streams, including but not limited to data returned from a subway gate, such as information about current passengers entering a station, information about speed of entering the station, and information about whether passengers choose to scan palm or use a subway card. A user device receives the returned data, such as information about a palm prints recognition situation, information about recognized speed, and information about whether there is a misjudgment. Therefore, the server may acquire a domain model diagram corresponding to the palm-scan system in the subway transportation scenario. For example, the server may acquire a UML diagram corresponding to the palm-scan system in the subway transportation scenario, and the server may further simultaneously acquire different data source entities, such as passengers and subway gates, in the palm-scan system in the subway transportation scenario.

Operation 204: Determine relationship data among all domain entities in the domain model diagram based on a first representation vector of the domain model diagram.

The first representation vector is a vector configured for describing the domain model diagram. Since the domain model diagram is prepared by the developer for each service system, the first representation vectors acquired by converting different domain model diagrams may also be different.

The domain entity refers to a concept or an object described in the domain model diagram, that is, an entity described in the domain model diagram. The domain entity in this application mainly represents the data source entity. For example, if domain model diagram A includes Entity1 and Entity2, then Entity1 and Entity2 are both domain entities. The relationship data between the domain entities is configured for reflecting a relationship between Entity1 and Entity2. For example, an entity relationship triplet between the domain entities extracted from domain model diagram A is {Entity1, Entity2, generalization}.

The relationship data is data for representing a relationship between domain entities. The relationship data in this application may be a relationship feature for representing a relationship between domain entities. For example, the relationship data may be {Entity1, Entity2, generalization}, reflecting that the relationship between Entity1 and Entity2 is generalization.

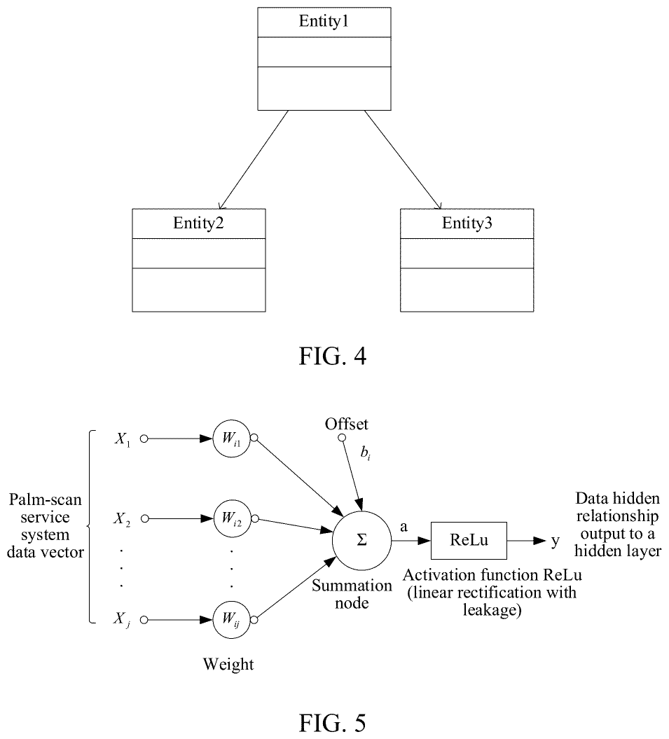

Specifically, after the server acquires the domain model diagram of the service system and the at least two entity data sources, the server may determine the relationship data among all the domain entities in the domain model diagram based on the first representation vector of the domain model diagram. In other words, the server may convert the domain model diagram into a computable representation vector, and determine relationships among all the domain entities in the domain model diagram based on the representation vector. For example, FIG. 3 is a schematic diagram of a domain model. The domain model is generally expressed by using the UML diagram. The UML diagram can be converted, according to a rule, into a vector describing the diagram. In other words, the UML diagram is a tool for describing an entity relationship. The server may convert the domain model diagram as shown in FIG. 3 into an entity relationship triplet: {Entity1, Entity2, generalization}. FIG. 4 is a schematic diagram of another domain model. The server may extract entity relationship triplets from the domain model diagram shown in FIG. 4, which are {Entity1, Entity2, Entity3, one-way association}, {Entity2, Entity3, variable}, {Entity1, Entity2, member variable}, {Entity1, Entity3, member variable}. Alternatively, the server may continue to mine, from the domain model diagram as shown in FIG. 4, a relationship between an entity and an entity combination, which is {Entity1, {Entity2, Entity3}, one-way association}.

Operation 206: Determine a data source entity relationship and data stream relationship between the at least two data sources and impact factors of the at least two data sources based on the relationship data and the at least two data sources.

The data source entity relationship is an association relationship between data source entities. For example, the association relationship includes but is not limited to one-way association, generalization, combination, derivation, aggregation, and other relationships.

Data stream refers to a set of ordered data sequences having a starting point and an ending point, including an input stream and an output stream. The data stream is defined as a sequence of data that is read in a specified order. The data stream relationship in this application is the data stream relationship between the at least two data source entities. The data stream relationship between data source entities may be understood to be a data stream relationship that includes original service data and that is acquired based on the data source entity relationship between the at least two data source entities and original service data respectively corresponding to the at least two data source entities. The data stream relationship may also be understood as a formal description of a data propagation path within a system, that is, a formal description of the data stream. For example, the data stream relationship in this application may be expressed in the form of a vector, and an update to each component of the vector is in the form of two-tuple stream.

The impact factor refers to a parameter configured for reflecting the relationship between data source entities. A larger value corresponding to the impact factor indicates a greater weight. For example, it is assumed that five association relationship items between TableInfo and RouteKey are: one-way association relationship, generalization relationship, combination relationship, derivative relationship, and aggregation relationship. It can be learned from (Tablelnfo,RouteKey,0.9,0,0,0,0,1,2,0) that impact factors corresponding to the five association relationship items are: (0.9,0,0,0,0). Assuming that a preset threshold is 0.9, and since an impact factor of the one-way association relationship is 0.9 and meets the preset threshold, it may be determined that the association relationship between TableInfo and RouteKey is the one-way association relationship.

Specifically, after the server determines the relationship data among all the domain entities in the domain model diagram based on the first representation vector of the domain model diagram, the server may use the relationship data among all the domain entities in the domain model diagram and the at least two data source entities as input data into a pre-trained deep neural network model. After the deep neural network model processes the input data, the data source entity relationship between and the impact factors of the at least two data source entities are outputted. Further, the server may acquire original data corresponding to the at least two data source entities of the service system, and determine the data stream relationship between the at least two data source entities based on the data source entity relationship between and the impact factors of the at least two data source entities outputted by the deep neural network model, and the original data corresponding to the at least two data source entities. In other words, the server combines the acquired original data corresponding to the at least two data source entities of the service system with the data source entity relationship between and the impact factors of the at least two data source entities outputted by the deep neural network model, to acquire the combined data stream relationship between the at least two data source entities including the original data. In other words, the server may use a relevant domain entity relationship extracted from the domain model diagram as a factor for parameter adjustments for the deep neural network model, so that the deep neural network model can mine an optimal relationship between the data source entities.

A pre-trained deep neural network model in this application is essentially a nonlinear decision boundary classifier. The input data is a product of an input vector and a vector weight, output data is acquired by forward calculation on a loss value, and a gradient parameter is adjusted by a back propagation method. In other words, the pre-trained deep neural network model in this application can acquire an optimal model parameter based on labeled data pre-training.

For example, it is assumed that the input data includes two entity items, five association relationship items, two quantity items, and one additional item. The five association relationship items are: one-way association relationship, generalization relationship, combination relationship, derivative relationship, and aggregation relationship. The server may use the following data:
(Repository,Tablelnfo,1,0,0,2,1,1,1,1)
(Tablelnfo,RouteKey,0,0,0,2,1,1,2,1)
(Repository,RouteKey,0,0,0,2,1,1,5,1)
(Tablelnfo,Field,1,0,0,2,1,1,7,1)
(Repository,Field,1,0,1,2,1,1,9,1)

as the input data into the pre-trained deep neural network model. After the deep neural network model processes the input data, acquired output data is:
(Repository,Tablelnfo,0.9,0,0.1,0,1.2,1,1,1)
(TableInfo,RouteKey,0.2,0,0,0,0,1,2,1)
(Repository,RouteKey,0.3,0,0,0,0.4,1,5,1)
(TableInfo,Field,1.3,0,0.5,0.2,0,1,7,1)
(Repository,Field,1.1,0.1,0.6,2.3,1.7,1,9,1)

Functions of the output data are:

(Repository,TableInfo,0.9,0,0.1,0,1.2,1,1,0): An association relationship between Repository and TableInfo is recommended to be a one-way association relationship, and a quantity relationship is 1 to 1.

(TableInfo,RouteKey,0.9,0,0,0,0,1,2,0): An association relationship between TableInfo and RouteKey is a one-way association relationship, and a quantity relationship is 1 to 2.

(Repository,RouteKey,0.3,0,0,0,0.4,1,5,0): There is no association relationship between Repository and RouteKey. Assuming that thresholds of all items are not met, no data is generated.

(TableInfo,Field,0.3,0,0.1,0.9,0,1,7,0): An association relationship between TableInfo and Field is an aggregation relationship.

(Repository,Field,0,9.1,0.6,0.3,0,1,9,0): An association relationship between Repository and Field is a one-way association relationship.

Operation 208: Generate a dashboard for visualizing data streams of the service system based on the data source entity relationship, the data stream relationship, and the impact factors.

A dashboard is a data dashboard, and the data dashboard is a carrier of data visualization. The data dashboard is a visualization tool that presents visual data more intuitively and vividly based on appropriate page layout and an appropriate effect design. The data dashboard is a communication tool that enables, based on data disclosure and presentation, different users to share useful information and activate communication and collaboration between organizations. In other words, the data dashboard intuitively reflects a change in service data through concise data visualization presentation. A problem is quickly and clearly found and service growth is facilitated through a data-driven recommendation method. Most basic information (such as inventory data) is integrated, so that a user quickly grasps a service condition by using the dashboard.

The data stream dashboard in this application is a data monitoring platform that displays a data change in real time. For example, in a display interface corresponding to the data stream dashboard, there is information such as a monitored data source entity, a monitored event, and an impact between monitored data sources. The data stream dashboard plays an important role in collecting and controlling information on a service operation situation. For example, the data stream dashboard in this application may be a dashboard for a large quantity of data streams in the subway transportation service scenario of the palm-scan system. In other words, the data stream dashboard of the palm-scan system means visually displaying a large quantity of data streams in the subway transportation service scenario from different dimensions.

A visual data stream dashboard means displaying monitored data in a visual manner, for example, intuitively displaying the monitored data in the manner of a visual chart.

Specifically, after the server determines the data source entity relationship and data stream relationship between the at least two data sources and the impact factors of the at least two data source entities based on the relationship data and the at least two data source entities, the server may generate, based on the data source entity relationship and data stream relationship between the at least two data sources and the impact factors of the at least two data source entities, the visual data stream dashboard corresponding to the service system. In other words, the data source entity relationship in this application is configured for guiding the generation of the data dashboard. Since there is one-to-one correspondence between the domain entity and the data source entity in the domain model diagram, a good domain entity relationship in the domain model diagram is needed to acquire a more accurate data source entity relationship.

In this application, a good entity relationship of the domain model diagram is selected as a training set to train the deep neural network model. Therefore, when a UML diagram of a new service system is subsequently imported, the pre-trained deep neural network model may be used to determine a theoretically better domain entity relationship in a domain model and convert the domain entity relationship into the data source entity relationship. The relationship between the data source entities acquired in this way is more accurate, has strong correlation, and the like, which can be used as a guide for building the data stream dashboard.

For example, an example of a palm-scan system used in a subway transportation scenario is used for description. The server may acquire domain model diagram A and a plurality of data source entities of the palm-scan system used in the subway transportation scenario, and determine relationship data among all domain entities in domain model diagram A based on a first representation vector of domain model diagram A. Further, the server may use the acquired relationship data among all the domain entities and all the data source entities as input layer data into the pre-trained deep neural network model. After the deep neural network model processes the input layer data, a data source entity relationship between and impact factors of all the data source entities are outputted.

It is assumed that the data source entity relationship and the impact factors outputted by the deep neural network model are: (T1,S1,0.9,0,0,0,0,1,2,0), which means that an association relationship between T1 and S1 is a one-way association relationship, and a quantity relationship is 1 to 2. T1 represents passage speed, and S1 represents recognition speed. Then the server can acquire original data corresponding to data source entities T1 and S1. For example, the acquired original data corresponding to data source entity T1 at moment t is 1 min, and the original data corresponding to data source entity S1 at moment t is 2 s. Further, the server may determine a data stream relationship between all the data source entities based on the acquired original data corresponding to data source entities T1 and S1, the data source entity relationship and the impact factors outputted by the deep neural network model. The server may perform data aggregation on the data stream relationship between all the data source entities, the original data corresponding to data source entities T1 and S1, and the data source entity relationship and the impact factors outputted by the deep neural network model to acquire aggregated data, and generate, based on the aggregated data, a visual data stream dashboard corresponding to the palm-scan system used in the subway transportation scenario.

In this embodiment, the relationship data among all the domain entities in the domain model diagram is determined, by acquiring the domain model diagram of the service system and different data source entities, based on the first representation vector of the domain model diagram; the data source entity relationship and data stream relationship between the at least two data sources and the impact factors of all the data source entities are determined based on the relationship data and all the data source entities; and the visual data stream dashboard corresponding to the service system is generated based on the data source entity relationship, the data stream relationship, and the impact factors. Since the relationship data between the domain entities is determined based on the domain model diagram of the service system, a higher quality data source entity relationship and data stream relationship may be determined based on the relationship data between the domain entities and all the data source entities, which expresses impacts hidden in multi-layer relationships between a plurality of data source entities, and more accurate impact factors are acquired, to enable a higher-quality data stream dashboard to be generated based on the data source entity relationship, the data stream relationship, and the impact factors, thereby reducing labor costs, reducing redundant data, reducing time consumption on intermediate data collection, and also effectively improving efficiency of generating the data stream dashboard while quality of the data stream dashboard is effectively improved.

In one embodiment, the method further includes:
performing vectorization processing on the domain model diagram to acquire the first representation vector of the domain model diagram.

The operation of determining relationship data among all domain entities in the domain model diagram based on a first representation vector of the domain model diagram includes:
performing vectorization processing on the domain model diagram to acquire the first representation vector of the domain model diagram;
determining relationship data between a target domain entity and a combination of other domain entities in the domain model diagram based on the first representation vector; or
determining the relationship data among all the domain entities in the domain model diagram based on the first representation vector.

The target domain entity are one or more domain entities selected from a plurality of domain entities, and the combination of other domain entities is a combination of other domain entities in the domain model diagram than the target domain entity. For example, a domain model diagram of a service system includes three domain entities: Entity1, Entity2, and Entity3. Entity1 is selected as the target domain entity. Then, a combination of Entity2 and Entity3 may be used as the combination of other domain entities. In other words, the combination of other domain entities is {Entity2, Entity3}.

Specifically, after the server acquires the domain model diagram of the service system, the server may perform vectorization processing on the domain model diagram by using a domain model module to acquire the first representation vector of the domain model diagram, and determine the relationship data between the target domain entity and the combination of other domain entities in the domain model diagram based on the first representation vector. Alternatively, the server determines the relationship data among all the domain entities in the domain model diagram based on the first representation vector. In other words, the server of this application may convert the domain model diagram into data in computable vector form by using the domain model module, to parse the relationship data for representing the relationship between entities.

The domain model module in this application may be configured to parse the domain model diagram of the service system. The domain model diagram may describe a lot of content. The domain model diagram used in this embodiment of this application only retains the relationship between the data source entities. In other words, this embodiment of this application only includes the data source entity, and an entity that is not a data source entity is not considered. For example, a car generates data, but a car manufacturer does not generate data. There is correspondence between the car and the car manufacturer, and the car manufacturer is also expressed in the domain model diagram. However, the car manufacturer is not considered when the server extracts the data source entity relationship from the domain model diagram. This rule may be predefined manually.

For example, FIG. 3 is a schematic diagram of a domain model. The server may perform vectorization processing on the domain model diagram as shown in FIG. 3 to acquire the first representation vector of the domain model diagram, and determine the entity relationship triplet in the domain model diagram based on the first representation vector, which is {Entity1, Entity2, generalization}. In some embodiments, the server determines that a relationship between Entity1 and Entity2 is generalization.

FIG. 4 is a schematic diagram of another domain model. The server may perform vectorization processing on the domain model diagram as shown in FIG. 4 to acquire a first representation vector of the domain model diagram, and determine the relationship data between the target domain entity and the combination of other domain entities in the domain model diagram based on the first representation vector, which is {Entity1, {Entity2, Entity3}, one-way association}. In some embodiments, the server determines that a relationship between target domain entity Entity1 and combination {Entity2, Entity3} of other domain entities is a one-way association. Therefore, a higher-quality data source entity relationship and data stream relationship that express impacts hidden in multi-layer relationships between a plurality of entities can be acquired based on past experience with a data source entity, such as a domain model diagram of a service system, and a manually annotated impact parameter of known data source entities, thereby providing more accurate relationship data for subsequent generation of a higher-quality data stream dashboard.

In one embodiment, the method further includes:
acquiring original data corresponding to the at least two data sources; and
selecting target data in the original data, and aggregating the data source entity relationship and data stream relationship between the at least two data sources and the impact factors of the at least two data sources with the target data to acquire first aggregated data.

The generating a dashboard for visualizing data streams of the service system based on the data source entity relationship, the data stream relationship, and the impact factors includes:
generating the data stream dashboard of the service system based on the first aggregated data.

The original data refers to a specific data value corresponding to the data source entity. For example, the data source entity is Entity2, and the original data corresponding to Entity2 is 2s.

The first aggregated data is data acquired by aggregating the data source entity relationship and data stream relationship between the at least two data sources and the impact factors of the data sources with the original data.

Specifically, after the server determines the data source entity relationship and data stream relationship between the at least two data sources and the impact factors of the at least two data source entities based on the relationship data between the domain entities in the domain model diagram and the at least two data source entities, the server may acquire the original data corresponding to the at least two data source entities and select a part of the original data as the target data, and aggregate the data source entity relationship and data stream relationship between the at least two data sources and the impact factors of the at least two data source entities with the target data, to acquire the first aggregated data. The first aggregated data includes not only an association relationship between the data source entities, but also the original service data corresponding to the data source entities. Therefore, the server may generate, based on the first aggregated data, the visual data stream dashboard corresponding to the service system.

For example, it is assumed that the server determines the data source entity relationship between and the impact factors of the data source entities based on the relationship data between the domain entities and all the data source entities in the domain model diagram, which are (Repository,Field,0,9.1,0.6,0.3,0,1,9,0), which means that an association relationship between Repository and Field is a one-way association relationship. Then the server may acquire the original data corresponding to data source entities Repository and Field respectively. It is assumed that the server acquires the original data corresponding to the data source entities Repository and Field, which is {A1, A2, A3, B1, B2, B3, B4}. The server may select, according to a preset rule, the target data from the original data {A1, A2, A3, B1, B2, B3, B4}, which is {A1, A2, B1, B2}, and aggregate the data source entity relationship and data stream relationship between the at least two data sources and the impact factors of all the data source entities with the target data {A1, A2, B1, B2} to acquire aggregated data S. Aggregated data S includes the data source entity relationship, the data stream relationship, the impact factors, and original service data. Therefore, the server may generate, based on aggregated data S, the visual data stream dashboard corresponding to the service system. Therefore, this can provide a higher-quality data stream dashboard for service development, reduce labor costs, reduce redundant data, improve the maintainability of the data stream dashboard, and empower service exploration more effectively.

In one embodiment, the method further includes:
acquiring original data corresponding to the at least two data sources; and
aggregating the data source entity relationship and data stream relationship between the at least two data sources and the impact factors of the at least two data sources with the original data to acquire second aggregated data.

The generating a dashboard for visualizing data streams of the service system based on the data source entity relationship, the data stream relationship, and the impact factors includes:
generating the data stream dashboard of the service system based on the second aggregated data.

The second aggregated data is configured for distinguishing the second aggregated data from the first aggregated data to represent another aggregated data.

Specifically, after the server determines the data source entity relationship and data stream relationship between the at least two data sources and the impact factors of the at least two data source entities based on the relationship data between the domain entities in the domain model diagram and the at least two data source entities, the server may acquire the original data corresponding to the at least two data source entities and aggregate the data source entity relationship and data stream relationship between the at least two data sources and the impact factors of the at least two data source entities with the original data, to acquire the second aggregated data. The second aggregated data includes not only an association relationship between the data source entities, but also the original service data corresponding to the data source entities. Therefore, the server may generate, based on the second aggregated data, the visual data stream dashboard corresponding to the service system.

For example, it is assumed that the server determines the data source entity relationship between and the impact factors of the data source entities based on the relationship data between the domain entities and all the data source entities in the domain model diagram, which are (Repository,Field,0,9.1,0.6,0.3,0,1,9,0), which means that an association relationship between Repository and Field is a one-way association relationship. Then the server may acquire the original data corresponding to data source entities Repository and Field respectively. It is assumed that the server acquires the original data corresponding to the data source entities Repository and Field, which is {A1, A2, A3, B1, B2, B3, B4}. The server may aggregate the data source entity relationship and data stream relationship between the at least two data sources and the impact factors of all the data source entities with the original data {A1, A2, A3, B1, B2, B3, B4} to acquire aggregated data S1. Aggregated data S1 includes the data source entity relationship, the data stream relationship, the impact factors, and original service data. Therefore, the server may generate, based on aggregated data S1, the visual data stream dashboard corresponding to the service system. Therefore, this can provide a higher-quality data stream dashboard for service development, reduce labor costs, reduce redundant data, improve the maintainability of the data stream dashboard, and empower service exploration more effectively.

In one embodiment, the operation of generating a dashboard for visualizing data streams of the service system based on the data source entity relationship, the data stream relationship, and the impact factors includes:
using aggregated data as configuration data of a platform back end, so that a platform front end generates the data stream dashboard of the service system based on the configuration data, the aggregated data being the first aggregated data or the second aggregated data, and the platform back end and the platform front end being a back end and front end of a platform of the data stream dashboard respectively.

The aggregated data is data acquired by aggregating the data source entity relationship and data stream relationship between the at least two data sources and the impact factors of the data sources with the original data. For example, the aggregated data in this embodiment of this application may include the foregoing first aggregated data and second aggregated data.

Specifically, after the server determines the data source entity relationship and data stream relationship between the at least two data sources and the impact factors of the at least two data source entities based on the relationship data and the at least two data source entities, the server may acquire the original data corresponding to the at least two data source entities and select the target data in the original data, and aggregate the data source entity relationship and data stream relationship between the at least two data sources and the impact factors of the at least two data source entities with the target data, to acquire the first aggregated data. Further, the server may use the first aggregated data as the configuration data of the platform back end, so that the platform front end generates, based on the configuration data, the visual data stream dashboard corresponding to the service system, the platform back end and the platform front end being the back end and front end of the platform of the data stream dashboard respectively.

In addition, after the server acquires the original data corresponding to different source entities, the server may further aggregate the data source entity relationship and data stream relationship between the at least two data sources and the impact factors of all the data source entities with the original data, to acquire the second aggregated data. The server may use the second aggregated data as the configuration data of the platform back end, so that the platform front end generates, based on the configuration data, the visual data stream dashboard corresponding to the service system.

In this embodiment, the data source entity relationship and data stream relationship between the at least two data sources and the impact factors of all the data source entities are aggregated with different original data, to acquire different aggregated data. Therefore, different aggregated data may ultimately be used as the configuration data for the platform back end, so that the platform front end may generate, based on the configuration data, the visual data stream dashboard that meets a service requirement or a product requirement, to enable the data stream dashboard to represent a data stream situation that better meets the service requirement or the product requirement.

In one embodiment, the method further includes:
displaying the data stream dashboard via the platform front end, the data stream dashboard including a visual data chart and a download button; and
downloading the visual data chart in response to a triggering operation on the download button, or exporting the data stream dashboard.

The platform front end is the front end of the platform of the data stream dashboard. The front end in this application is mainly configured to generate a visual data curve based on the configuration data generated by the back end and provide functions such as downloading an excel report.

Specifically, when the server, that is, the platform of the data stream dashboard generates, based on the data source entity relationship, the data stream relationship, and the impact factors, the visual data stream dashboard corresponding to the service system, the server displays the data stream dashboard via the platform front end. The data stream dashboard displayed in an interface includes the visual data chart and the download button. Further, the server downloads, in response to the user's triggering operation on the download button, the visual data chart displayed in the current interface, or exports the data stream dashboard displayed in the current interface. The user's triggering operation may include different triggering operations. For example, the triggering operation may be a click/tap operation, a sliding operation, a long press operation, a shaking operation, and another triggering operation.

For example, the server displays the data stream dashboard via the platform front end. It is assumed that the data stream dashboard displayed in the interface includes visual data charts, which are line graph 1 and sector chart 2. When a developer needs to download a visual data chart displayed in the current data stream dashboard, the developer may double-click/tap an icon of line graph 1, and the server downloads, in response to the developer's double-click/tap operation, line graph 1 displayed in the current interface to the local. Therefore, this can provide a higher-quality data stream dashboard for service development, reduce labor costs, reduce redundant data, and improve the maintainability of the data stream dashboard, so that the developer can empower service exploration more effectively.

In one embodiment, the operation of determining a data source entity relationship and data stream relationship between the at least two data sources and impact factors of the at least two data sources based on the relationship data and the at least two data sources includes:
processing the relationship data and identification information of the at least two data sources by using a deep neural network model to acquire the data source entity relationship between and the impact factors of the at least two data sources; and
determining the data stream relationship between the at least two data sources based on the data source entity relationship between and the impact factors of the at least two data sources, and the original data corresponding to the at least two data sources.

The identification information is information configured for uniquely identifying the data source entity. The identification information may be customized identification information. For example, a name of the data source entity may be used as the identification information of the data source entity. Assuming that the data source entity is named Repository, and then the identification information of the data source entity is Repository.

Specifically, when the server determines the data source entity relationship and data stream relationship between the at least two data sources and the impact factors of the at least two data source entities based on the relationship data and the at least two data source entities, the server may process the relationship data and the identification information of the at least two data source entities by using the pre-trained deep neural network model to acquire the data source entity relationship between and the impact factors of the at least two data source entities. Further, the server may acquire the original data corresponding to the at least two data source entities, and determine the data stream relationship between the at least two data source entities based on the data source entity relationship between and the impact factors of the at least two data source entities, and the original data corresponding to the at least two data source entities.

For example, it is assumed that the relationship data among all the domain entities and all the data source entities in the domain model diagram are: (repository, kv table information, direct association, 1, 1, with a derivative). Then the server inputs the above relationship data and the identification information of the data source entities as input data into the pre-trained deep neural network model. In other words, the input data is: (Repository,Tablelnfo,1,0,0,2,1,1,1,1). After processing by the deep neural network model, outputted data source entity relationship between and the impact factors of all the data source entities are: (Repository,TableInfo,0.9,0,0.1,0,1.2,1,1,1). The outputted data indicates that an association relationship between Repository and TableInfo is a one-way association relationship, and a quantity relationship is 1 to 1.

Further, the server may acquire the original data corresponding to Repository and TableInfo. The original data is displayed in the form of JSON. Generally, necessary fields are a data source entity name, time, and a service field. The server determines the data stream relationship between Repository and TableInfo based on the data source entity relationship between and the impact factors of Repository and TableInfo, and the original data corresponding to Repository and TableInfo. Therefore, a higher-quality data source entity relationship and data stream relationship that express impacts hidden in multi-layer relationships between a plurality of entities can be generated and a more accurate impact parameter can be acquired based on past experience with a data source entity, that is, a domain model diagram of a service system, a manually annotated impact parameter of known data source entities, and the like.

In one embodiment, the operation of processing the relationship data and identification information of the at least two data sources by using a deep neural network model to acquire the data source entity relationship between and the impact factors of the at least two data sources includes:
acquiring initial impact factors of the at least two data sources; and
processing the relationship data, the at least two data sources, and the initial impact factors of the at least two data sources by using the deep neural network model, to acquire the data source entity relationship between and the impact factors of the at least two data sources.

The initial impact factors refers to initial weight parameters set for different data source entities. For example, the initial impact factor may be set to a fixed value or an empirical value.

Specifically, the server processes the relationship data and the identification information of the at least two data source entities by using the pre-trained deep neural network module to acquire the data source entity relationship between and the impact factors of the at least two data source entities. The pre-trained deep neural network module in this embodiment of this application is a typical neural network structure for performing deep learning, and may be divided into an input layer, a plurality of hidden layers, and an output layer. Internal details include a neuron, an excitation function, and the like. The pre-trained deep neural network module is configured to mine a relationship between data source entities and impact factors of data streams from the data streams of the data source entities, and use the mined relationship between data source entities and the impact factors of the data streams as configuration parameters for a back end of a low-code generating module of a data dashboard. Input data of the data source entity neuron is a vector converted from service data. An initial weight, that is, the initial impact factor, may be preset for different input vectors. To adjust an impact of a weight on final data of the neuron, the entire pre-trained deep neural network module adjusts a parameter based on a back propagation technology of deep learning. For example, a composition formula of neurons used in a palm-scan service system is: A multi-dimensional palm-scan system data vector+a weight+activation function ReLu+a data hidden relationship vector outputted to a hidden layer. Activation function ReLu may use linear rectification with leakage, that is, Parametric ReLu. A parameter α in Parametric ReLu is a learnable variable.

For example, the server may convert data source entities Repository and TableInfo into vector data to acquire data source entity vectors X1 and X2. Further, the server may acquire initial impact factors of data source entities Repository and TableInfo, which are wi1 and wi2 respectively. The server uses the relationship data among all the domain entities, data source entity vectors X1 and X2, and initial impact factors wi1 and wi2 in the domain model diagram as input layer data into the pre-trained deep neural network module. After the pre-trained deep neural network module processes the relationship data among all the domain entities, data source entity vectors X1 and X2, and initial impact factors wi1 and wi2 in the domain model diagram, the data source entity relationship between and impact factors wo1 and wo2 of data source entities Repository and TableInfo are outputted. Final output impact factors wo1 and wo2 in this embodiment of this application are more accurate impact factors acquired by adjusting, by using the deep neural network model, inputted initial impact factors wi1 and wi2.

In this embodiment, after the deep neural network model adjusts the inputted initial impact factors, more accurate impact factors may be acquired, to enable a low-code generation platform of the data stream dashboard to generate a high-quality data stream dashboard based on the data source entity relationship, the data stream relationship, and the more accurate impact factors.

In one embodiment, the method further includes:
selecting a target impact factor meeting a threshold condition from the impact factors; and
acquiring a data source entity relationship corresponding to the target impact factor, and using the data source entity relationship as a target data source entity relationship.

The target impact factor is an impact factor that is selected from a plurality of candidate impact factors and that meets the threshold condition. For example, assuming that the candidate impact factors include: (0.9,0,0,0,0.3), then candidate impact factor 0.9 that meets the threshold condition may be selected as the target impact factor.

Specifically, the server may acquire the initial impact factors of all the data source entities, and use the relationship data among all the domain entities, all the data source entities, and the initial impact factors of all the data source entities extracted from the domain model diagram as input data into the pre-trained deep neural network model. After processing by the deep neural network model, the data source entity relationship between and the impact factors of all the data source entities are acquired. Further, the server may select the target impact factor meeting the threshold condition from the impact factors. For example, assuming that the threshold condition is that the impact factor is greater than or equal to 0.9, then the server may select an impact factor greater than or equal to 0.9 from the plurality of impact factors as the target impact factor, acquire the data source entity relationship corresponding to the target impact factor, and use the data source entity relationship as the target data source entity relationship.

For example, it is assumed that the threshold condition is set to: The impact factor is greater than or equal to 0.9. The plurality of candidate impact factors outputted by the deep neural network model are: (Repository,Tablelnfo,0.9,0,0.1,0,1.2,1,1,1). The first three items represent impact factors of association relationship items. Since 0.9 meets the threshold condition, the server may select 0.9 as the target impact factor from the plurality of candidate impact factors (0.9,0,0.1), acquire a data source entity relationship corresponding to the target impact factor 0.9 as a one-way association relationship, and use the one-way association as the data source entity relationship between Repository and TableInfo. Therefore, a more direct and accurate relationship between data source entities is determined based on impact factors, thereby providing a higher-quality data stream dashboard for service development, reducing labor costs, reducing redundant data, reducing time consumption on intermediate data collection, effectively improving efficiency of data stream dashboard generation, and empowering service exploration more effectively.

In one embodiment, the data source entity relationship and the impact factors are acquired by processing, by using the deep neural network model, the relationship data and the at least two data sources. The method further includes:
acquiring a data source entity sample and converting the data source entity sample into vector data;
performing data aggregation on all pieces of vector data based on different dimensions to acquire aggregated vector data;
configuring a relationship between at least two pieces of the aggregated vector data to acquire a relationship data sample; and
training the deep neural network model based on the aggregated vector data and the relationship data sample.

The vector data is data in vector form. For example, if the data source entity sample is in JSON form, the data source entity sample is converted into a sample in vector form.

Specifically, when training an initial deep neural network model, the server may acquire the data source entity sample and convert the data source entity sample into the vector data. Since all data source entities may include entities of different dimensions, the server may perform data aggregation on vector data of different dimensions corresponding to the data source entities to acquire aggregated vector data. Further, the server may configure a relationship between and initial impact factors of at least two pieces of the aggregated vector data. In other words, the server may configure a relationship between and initial weights of different data source entities in a training set to acquire a relationship data sample. The server trains the deep neural network model based on the aggregated vector data and the relationship data sample.

For example, an example of a palm-scan system used in a subway transportation scenario is used for description. FIG. 5 is a schematic diagram in which a deep neural network model processes input data of an input layer. When training an initial deep neural network model, the server may acquire a plurality of data source entity samples of a palm-scan service system and convert the plurality of data source entity samples into vector data. The acquired vector data includes: X11, X12, X21, X3i, . . . , Xji. Further, the server may perform data aggregation on all pieces of vector data based on different dimensions to acquire aggregated vector data. For example, X11 and X12 are vector data of different dimensions of an entity. Then, vector data X11 and X12 are aggregated based on the entity dimensions to acquire aggregated data X1. In the palm-scan service system used in the subway transportation scenario, X1 may represent palm-scan recognition speed, and X2 may represent a passenger's passage speed. After the server acquires the aggregated vector data, the server may configure a relationship between and initial impact factors of different aggregated vector data. In other words, the server may configure a relationship between and initial weights of different data source entities in a training set. For example, the server may configure a strong correlation between passenger's passage speed X2 and palm-scan recognition speed X1. A correlation coefficient may be calculated based on past experience. In some embodiments, the server may configure an initial impact factor of the two vectors of passenger's passage speed X2 and palm-scan recognition speed X1 to be 0.3. The initial impact factor corresponds to a hidden relationship between a plurality of data source entities that need to be mined in the future. In other words, a relationship data sample that the server may acquire is {X2, X1, 0.3}. It is assumed that the aggregated vector data acquired by the server is {X1, X2, X3, . . . , Xj}. The server may train the deep neural network model based on aggregated vector data {X1, X2, X3, . . . , Xj} and relationship data sample {X2, X1, 0.3}. Input data of the deep neural network model shown in FIG. 5 is vector data {X1, X2, X3, . . . , Xj} of the palm-scan service system.

In this embodiment of this application, the server may alternatively perform data aggregation on vector data based on other different dimensions, such as time, and a scene.

In this embodiment, a relationship feature of the domain entity in the service system domain model can be extracted, by pre-training the deep neural network model, in some embodiments, by using a good UML diagram entity relationship training set to train the deep neural network model, when the deep neural network model is used. Relationship extraction is performed on the inputted data source entity to acquire a relatively high-quality data source entity relationship. In other words, the deep neural network model may be used to directly mine a more direct and accurate entity relationship, so that a higher-quality data stream dashboard can be generated based on the more accurate entity relationship.

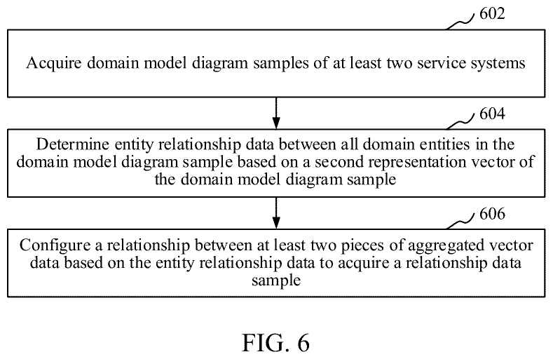

In one embodiment, as shown in FIG. 6, the operation of configuring a relationship between at least two pieces of the aggregated vector data to acquire a relationship data sample includes:

Operation 602: Acquire domain model diagram samples of at least two service systems.

Operation 604: Determine entity relationship data among all domain entities in each domain model diagram sample based on a second representation vector of the domain model diagram sample.

Operation 606: Configure the relationship between at least two pieces of the aggregated vector data based on the entity relationship data to acquire the relationship data sample.

The second representation vector is a vector configured for describing the domain model diagram sample. Since the domain model diagram sample is prepared by a developer for each service system, the second representation vectors acquired by converting different domain model diagram samples may also be different. The domain model diagram sample in this application may be a domain model diagram selected based on a target service scenario and corresponding to the target service scenario.

Specifically, when training an initial deep neural network model, the server aggregates vector data of different dimensions corresponding to all data source entities. After acquiring aggregated vector data, the server may acquire domain model diagram samples of different service systems, and determine entity relationship data among all domain entities in each domain model diagram sample based on the second representation vector of the domain model diagram sample. Further, the server may configure a relationship between different aggregated vector data based on the entity relationship data among all the domain entities in each domain model diagram sample to acquire a relationship data sample. In other words, the server may configure a relationship between and initial weights of different data source entities in a training set to acquire a relationship data sample, so that the server may subsequently train the initial deep neural network model based on the relationship data sample to acquire a trained deep neural network model.

For example, an example of a palm-scan system used in a subway transportation scenario is used for description. When training the initial deep neural network model, the server may acquire the domain model diagram sample of the palm-scan system used in the subway transportation scenario, and determine the entity relationship data among all the domain entities in the domain model diagram sample based on the second representation vector of the domain model diagram sample. It is assumed that the entity relationship data among all the domain entities in each domain model diagram sample that is determined by the server based on the second representation vector of the domain model diagram sample includes: {X2, X1, one-way association}. X1 represents palm-scan recognition speed, and X2 represents a passenger's passage speed. The server may configure a relationship between and initial weights of aggregated vector data X1 and X2 based on the entity relationship data {X2, X1, one-way association} among all the domain entities in each domain model diagram sample to acquire a relationship data sample, so that the server may subsequently train the initial deep neural network model based on the relationship data sample to acquire a trained deep neural network model. Therefore, a relationship feature of the domain entity in the service system domain model can be extracted, by pre-training the deep neural network model, in some embodiments, by using a good UML diagram entity relationship training set to train the deep neural network model, when the deep neural network model is used. Relationship extraction is performed on the inputted data source entity to acquire a relatively high-quality data source entity relationship. In other words, the deep neural network model may be used to directly mine a more direct and accurate entity relationship, so that a higher-quality data stream dashboard can be generated based on the more accurate entity relationship.

In one embodiment, this application further provides an application scenario. The foregoing method for generating a dashboard for visualizing data streams is applied to the application scenario. Specifically, application of method for generating a dashboard for visualizing data streams in this application scenario is as follows:

For a large amount of data that is continuously generated, when a dashboard for visualizing data streams needs to be established at a service management and control level for real-time management and control, the foregoing method for generating a dashboard for visualizing data streams may be used. In some embodiments, after a staff logs in to a dashboard for visualizing data streams platform, the data stream dashboard platform may automatically acquire a domain model diagram and different data source entities of a target service system, and determine relationship data among all domain entities in the domain model diagram based on a first representation vector of the domain model diagram. Further, the data stream dashboard platform may determine a data source entity relationship and data stream relationship between the at least two data sources and impact factors of all the data source entities based on relationship data and all the data source entities, and generate, based on the data source entity relationship, the data stream relationship, and the impact factors, a visual data stream dashboard corresponding to the target service system. The data stream dashboard may be implemented by an independent server or a server cluster combined by a plurality of servers.

The method provided in embodiments of this application may be applied to various service development scenarios, and may be further applied to an application that needs real-time monitoring on a relevant data stream. The following describes the method for generating a dashboard for visualizing data streams provided in embodiments of this application, by using an example in which the method serves a subway transportation service scenario of a palm-scan system.

In a conventional method, a dashboard for visualizing data streams is a relationship display of a few data source entities proposed for a service requirement, and is developed by a developer according to the service requirement. With development of a low-code platform, the developer is usually needed to manually configure a corresponding data source entity in a configuration system, and a service is organized on a front end to automatically generate a dashboard for visualizing data streams.

Disadvantages of the foregoing conventional method include:
(1) For the data stream dashboard, it is necessary to manually configure the data source entity.
(2) A relationship of the data source entity and an impact of a domain model of the service system on a data stream are ignored.
(3) There may be such as redundancy, and data expiration. Therefore, it is prone to poor quality of the final generated data stream dashboard.

In some embodiments, a data dashboard is specified based on a product or service requirement. In the conventional method, it is necessary to manually specify two or more dimensions, and then create data dashboards with different dimensions. For example, a relationship between a price and a car sales volume may be manually specified, which is proposed based on experience. A developer wants to acquire an impact of the overall car price on the car sales volume. In another data dashboard, a relationship between components and parts of a car and a car sales volume may alternatively be manually proposed. However, the price of the components and parts of a car is also related to an overall price of the car. Therefore, these two dashboards express repetitive and redundant logic. In other words, in the conventional method, the relationship of the data entity and an impact of a domain model of the service system on a data stream are ignored. In some embodiments, there is a large quantity of entity concepts, and a developer wants to find a relationship between the entity concepts. In dashboards including different entity concepts, content of a dashboard may be expressed by another dashboard.

For example, if a person has a plurality of identities, and one identity corresponds only to one ability, then in fact, only a dashboard showing correspondence between a person and abilities is needed. Correspondence between a person and identities, and correspondence between an identity and an ability are redundant in recording identity data. In other words, it is assumed that identity entities do not need to exist, and an optimal entity relationship to be mined is the direct correspondence between the person and the abilities.

The data expiration mainly means that there are excessive association levels between entities and a true relationship between data entities cannot be acquired in time. For example, in the conventional method, to collect a relationship between A and B, a relationship between B and C, and a relationship between C and D, only the relationship between A and D is needed to be collected without spending time collecting intermediate data. In other words, in the conventional method, manual configuration of the data source entity is required, the relationship of the data source entity is ignored, and there may be redundant logic, high data collection time consumption, and the like.

Therefore, to solve the foregoing problems, this application provides a high-quality method for generating a dashboard for visualizing data streams based on deep learning and a domain model. According to this method, the deep learning is used to first pre-train a large quantity of data streams in a subway transportation service scenario of a palm-scan system, build a neuron from data, quality, time, and other aspects of a data stream of each data source entity, and mine relationships between a plurality of data source entities and mutual impacts of a plurality of data streams. In addition, a high-quality domain model diagram of the subway transportation service scenario of the palm-scan system edited manually during development of the service system is acquired, and a relevant entity relationship in the domain model diagram is extracted as a factor for deep learning model parameter adjustments. This facilitates mining an optimal data source entity relationship and data stream relationship. In addition, the method provided in this application may be combined with a low-code data stream dashboard configuration method, to generate a corresponding high-quality data stream dashboard. An essence of the method provided in embodiments of this application is directly mining a more direct and accurate entity relationship. The more accurate entity relationship may be extracted based on a pre-drawn domain model diagram. The accurate entity relationship is configured for building a data dashboard to better express a relationship between entities.

Based on the technical solutions provided in this application, problems that can be solved include:
(1) For a plurality of known data source entities that need to find association relationships, a deep learning model trained based on a large amount of data can extract a relationship feature of a domain entity in a service system domain model, and perform relationship extraction on inputted data source entity to acquire a relatively high-quality data source entity relationship.
(2) A relationship between data source entities can be exploratorily mined.
(3) The data source entity relationship generated by the deep learning model is combined with a low-code dashboard generation method, to generate a higher-quality data stream dashboard.

The data source relationship in this application is configured for guiding data dashboard generation. An object that generates data in service may be referred to as a data source entity. For example, a car generates data of car price and data of car quality. In this case, the entity and the data source entity are both the car, and the car price and the car quality are data generated by the entity of the car, which may be attributes of the entity. For example, the car has a price, but the quality needs to be measured.

Since there is one-to-one correspondence between a domain entity and a data source entity expressed in a UML diagram, acquiring a good data source entity relationship is to acquire a good UML diagram entity relationship. Therefore, in this application, a good UML diagram entity relationship training set may be used to train a deep learning model, so that when a trained deep learning model is used, a UML diagram of a new project is inputted, and a better entity relationship of the UML diagram of the new project can be extracted in a domain model theory and can be converted into a data source entity relationship, to guide the relationship between data sources to be more direct and have strong correlation, which can be used as a guide for the construction of a dashboard for visualizing data streams. For example, according to the method provided in this application, a best entity relationship can be mined, which is direct correspondence between a person and an ability, and a dashboard for visualizing data streams of the relationship between the person and the ability can be directly constructed without time consumption on intermediate data collection.

The deep learning in this application means a machine learning method implemented using a pre-trained deep neural network model. The model is generally a pre-trained deep neural network model, including an input layer, a hidden layer, and an output layer (excitation function). Each layer includes a plurality of neurons. The model is acquired based on the pre-trained model and parameters, and can mine connections between the plurality of neurons.

Pre-trained deep neural network model: It is essentially a nonlinear decision boundary classifier. Input data is a product of an input vector and a vector weight, output data is acquired by forward calculation on a loss value, and a gradient parameter is adjusted by a back propagation method. In other words, an optimal model parameter can be acquired based on labeled data pre-training.

Domain model: It is a model representing a concept in a domain in a domain-driven design, often including a class diagram, a sequence diagram, and the like.

Domain entity: It is an entity in a domain model, usually including an entity, a control entity, and a boundary entity. The domain entity bears domain logic. In this embodiment of this application, a data source entity is mainly expressed.

Data stream dashboard: It is a data monitoring platform that displays a data change in real time. Generally, there is information such as a monitored data source entity, a monitored event, and an impact between monitored data sources. The data stream dashboard plays an important role in collecting and controlling information on a service operation situation.

Palm-scan system: It is a system acquiring identity authentication based on palm prints to acquire corresponding permission bound to identities to perform various tasks. This system may serve a large quantity of service systems. For example, for a service in a subway transportation scenario, the palm-scan system can be used to allow passengers to ride.

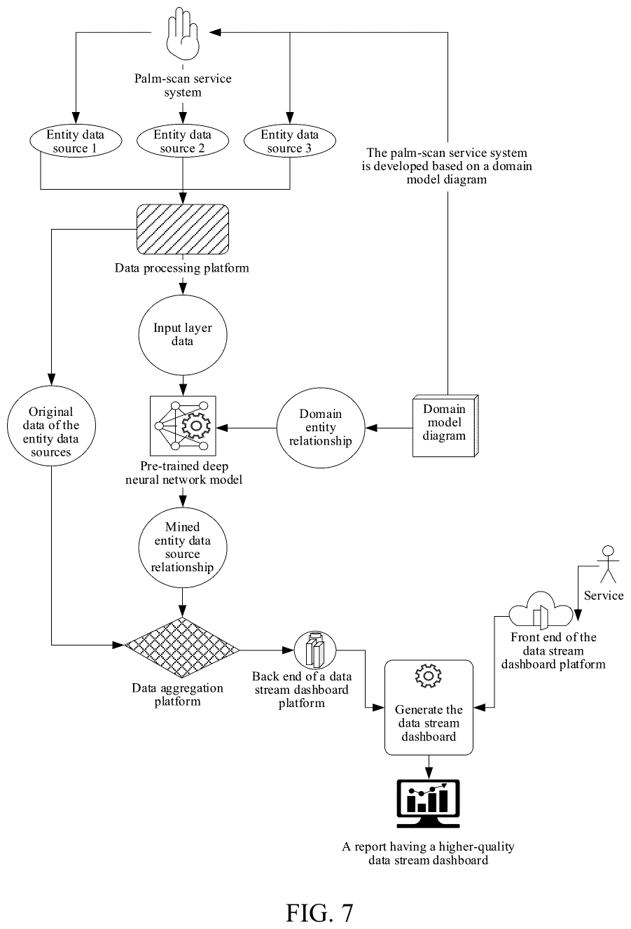

On a technical side, FIG. 7 is a schematic diagram of an overall architecture of a high-quality data stream dashboard method based on deep learning and a domain model. The high-quality data stream dashboard method based on deep learning and a domain model shown in FIG. 7 mainly includes four modules: a data source module, a pre-trained deep neural network module, a domain model module, and a data dashboard low-code generating module.

### 1. Data Source Module

It is a module that is mainly connected to a service system to acquire original data of a data source entity. In a subway transportation service scenario serving a palm-scan system, acquired original data of a data source entity of the palm-scan service system includes but is not limited to subway pass data, a recognition situation of the palm-scan system, recognition speed, and other data. The original data is divided into two parts for use. One part of the original data is used as an input layer data vector required for pre-training a deep neural network module, which to some extent has a function of generating a training set. The other part of the original data is used to extract a high-quality data source entity relationship.

The original data can be actively obtained from a log, tracing point, and the like. Final data is displayed in the form of JSON. Generally, required fields are a data source entity name, time, and a service field.

Operations for the data source module to generate a data set include:
first, acquiring original JSON data based on a log, a tracing point, and a service rule, and converting the original JSON data into vector format;
second, aggregating the original data based on a plurality of dimensions, such as a time dimension, an entity dimension, and a scene dimension;
third, cleaning relationship data of a data entity vector, and adjusting situations including bidirectional and duplicate-named entities, null value, assignment, and the like; and
fourth, configuring a training set. For example, there is a strong correlation between a passenger's passage speed and palm-scan recognition speed. A correlation coefficient may be calculated based on past experience. Impact factors of the two vectors, the passage speed and the palm-scan recognition speed, may be configured. The impact factors correspond to a hidden relationship between a plurality of data source entities that need to be mined later. The impact factors are impact parameters in a deep learning model. Essentially, all parameters of the deep learning model affect each other. This is a black box process inside the model.

### 2. Domain Model Module

It is a module that is configured to parse a domain model diagram of a service system. The module mainly converts the domain model diagram into a computable vector form and parses out a vector that can simply express a relationship between entities. The domain model diagram used in this embodiment only retains a relationship between data source entities as an impact factor that can be compared with a pre-trained deep neural network module.

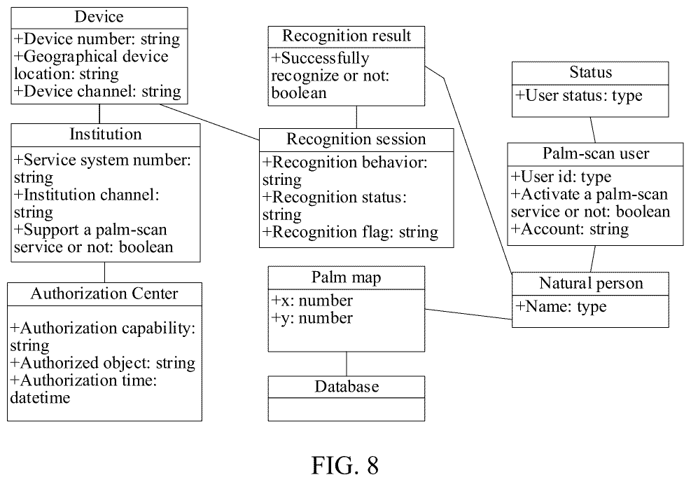

FIG. 8 is a domain model diagram of a data source entity of a palm-scan system. FIG. 8 is a simplified palm-scan system data source entity domain model diagram. A server may generate a basic entity relationship vector based on the domain model diagram shown in FIG. 8. In some embodiments, the server may extract, according to a preset rule, a vector that needs attention from the domain model diagram, for example, extract entity relationship vectors from the domain model diagram shown in FIG. 8, which are {(palm-scan user, natural person, direct association 0.1, aggregation 0.9, 0.2, 0.06, 0.7, 0, 0, 0, 0), (palm-scan user, status, user status, activate a palm-scan service or not, xx), (natural person, recognition result, successfully recognize or not, xx, xx, xx), (recognition session, recognition result, successfully recognize or not, recognition status), (recognition session, device)}. In the foregoing entity relationship vectors, 0.1 and 0.9 represent impact parameters, that is, impact factors, of different association relationship items. By analogy, a plurality of domain model diagrams of a service system may generate a plurality of vectors expressing entities and focusing on data source relationships. The domain model diagrams may further express basic relationship data such as an association relationship between entities, a quantity relationship between entities, and an indirect association relationship between entities. The relationship data may be acquired by rule configuration.

### 3. Pre-Trained Deep Neural Network Module

It is a module of a typical neural network structure for performing deep learning, and may be divided into an input layer, a plurality of hidden layers, and an output layer. Internal details include a neuron, an excitation functions, and the like. The module is responsible for mining a relationship between data source entities and impact factors of data streams from the data streams of the data source entities, and using the mined relationship between data source entities and the impact factors of the data streams as configuration parameters for a back end of a low-code generating module of a subsequent data dashboard.

Input of the data source entity neuron is a vector converted from service data JSON. An initial weight needs to be set for different vectors. This initial weight may be a fixed value or an empirical value. To adjust an impact of a weight on final output data of the neuron, the entire model adjusts a parameter based on a classic back propagation technology of deep learning. A composition formula of neurons used in a palm-scan service system is: A multi-dimensional palm-scan system data vector+a weight+activation function ReLu+a data hidden relationship vector output to a hidden layer. The relationship vector of the hidden layer is a vector of an intermediate stage of the deep learning model.

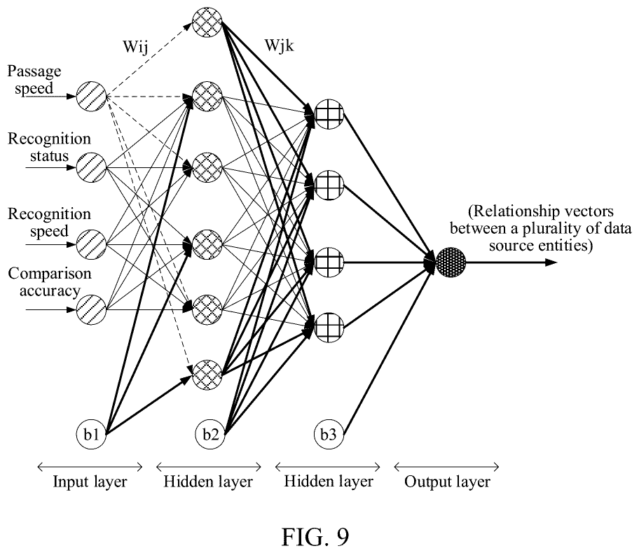

The activation function used in this embodiment of this application is a linear rectification function with leakage. In other words, the activation function is Parametric ReLu. The most important role of the linear rectification function with leakage is to adjust learning parameter α. For positive numbers, learning parameter α remains unchanged, and for negative numbers, learning parameter α is adjusted based on a loss value to control a change of the learning parameter. Since data expressed in a forward direction should be retained, the deep learning model in this application uses the linear rectification function with leakage. For example, there is a relationship between two entities. Determining of expressing that there is no relationship between two entities may be wrong, and this determining process occurs inside the deep learning model to reduce an impact of wrong determining. FIG. 9 is a schematic diagram of a structure of a multi-layer neural network for a subway transportation service scenario. Input vectors of input layer node b1 in FIG. 9 include passage speed, a recognition status, recognition speed, and comparison accuracy. A node of each hidden layer is essentially a vector, and a node of a next layer is affected by all nodes of a previous layer. For example, hidden layer nodes b2 and b3 in FIG. 9 are essentially vectors. Hidden layer node b2 is affected by all nodes of previous layer b1, and hidden layer node b3 is affected by all nodes of previous layer b2.

An entity relationship input layer is fully connected to form the hidden layer, in which forward calculation and weight calculation are performed. Each entity relationship neuron processes an input entity relationship vector from different angles and extracts a specific part of the information of the input vector. This information then is used in classification tasks to provide a basis for decision-making. Therefore, an essence of a single-layer entity relationship neuron is to process input of a neuron in an entity relationship input layer from different angles. The angle may be understood as a gradient.

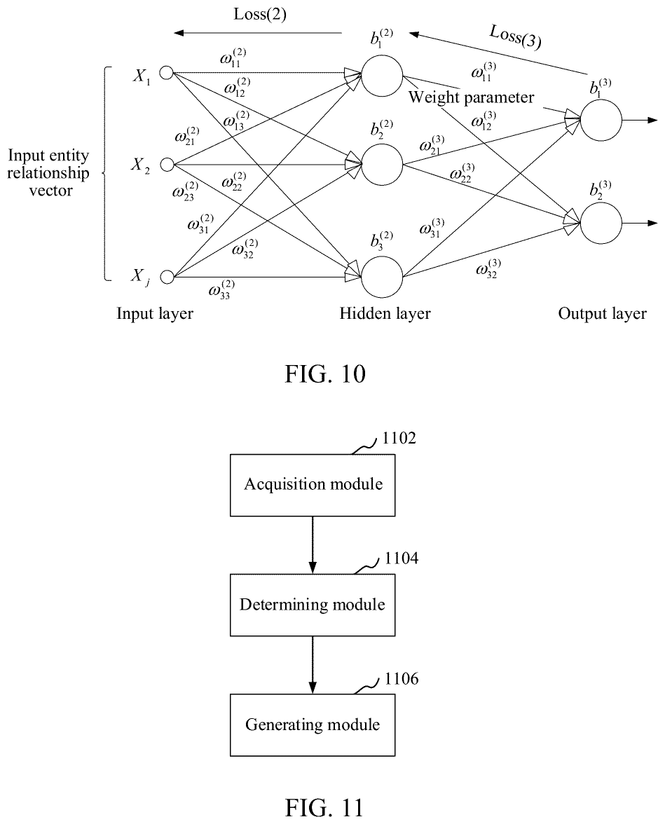

FIG. 10 is a schematic diagram of deep learning parameter adjustments. A neural network transmits output and calculates a loss value layer by layer through forward calculation and returns an error through back propagation, to adjust a parameter of the calculation, in some embodiments, to adjust a weight parameter of a neuron and a k variable of an excitation function in this embodiment of this application. This process is a classic process for deep learning parameter adjustments, and is only briefly described as a technology used in this application.

### 1. Forward Calculation

For example, [H11, H12, H13] represents a first vector of an entity relationship input variable matrix multiplied by weight matrix W. A result is as follows:

$$H 11 = W ( 1 ) 11 * X 1 + W ( 1 ) 21 * X 2 + W ( 1 ) 31 * X 3 + B 1$$

$$H 12 = W ( 1 ) 12 * X 1 + W ( 1 ) 22 * X 2 + W ( 1 ) 32 * X 3 + B 2$$

$$H 13 = W ( 1 ) 13 * X 1 + W ( 1 ) 23 * X 2 + W ( 1 ) 33 * X 3 + B 3$$

An adjusted ReLu function is performed on [H11, H12, H13] to acquire [F(H11), F(H12),F(H13)]. [OUT1,OUT2]=[F(H11),F(H12),F(H13)]*W2+B2, where W2 is the weight matrix. The adjusted ReLu function is performed on [OUT1, OUT2] to acquire [F(OUT1), F(OUT1)]. This is a forward calculation process. A loss value can be calculated by adding a loss function.

### 2. Back Calculation and Propagation

A key to training a neural network is to train a weight matrix and a bias of the neural network. The back propagation is to continuously adjust, based on a current parameter, an error generated form a sample to ensure that the error is as small as possible. A commonly used strategy for the neural network back propagation is a gradient descent method. According to the gradient descent method, the back propagation is implemented based on a chain rule of a partial derivative. The loss function selected in this application may be cross information entropy.

For vectorized data, loss function derivation needs to be performed layer by layer. For a single weight parameter, a corresponding error gradient may be obtained in forward calculation, so that a matrix representing the error gradient can be constructed. The matrix may be expressed as a sum of loss values back propagated from a next layer and an outer product of an activation function outputted in the forward calculation.
(1) Obtain the loss function, and multiply the loss function by a constant coefficient to express the error and obtain error expression E.
(2) Find a partial derivative of the error term for error expression E. Based on a second derivative chain rule, an expression can be similar to the following formula (1):

$$\frac{\partial E}{\partial {w}_{ji}} = \frac{\partial E}{\partial {o}_{j}} \frac{\partial {o}_{j}}{\partial {net}_{j}} \frac{\partial {net}_{j}}{\partial {w}_{ji}} \qquad ( 1 )$$

A derivative of neuron's output with respect to neuron's input is a partial derivative of the activation function, and a derivative expression may be obtained recursively.
(3) Select a learning rate a, and use the gradient descent method to update the weight parameter and λ of the activation function.

### 4. Data Dashboard Low-Code Generating Module

It is a module that is mainly divided into a configuration system back end and a visual front end for service configuration. The module may automatically generate a visual data stream dashboard based on configuration data.

The back end is mainly responsible for configuration of a data source entity and configuration of impact factors of entities, and may be regarded as a polynomial formula. The impact factors are coefficients in the polynomial formula. The configuration may be manually configured by back-end developers or may be configured automatically based on a relationship mined by a deep learning module. The configuration affects quality of the generated visual data dashboard, including but not limited to whether a relationship between entities can be more realistically displayed, such as promotion or suppression, whether there is an intermediate entity that plays a role in the relationship between entities, and the like.

The front end is mainly responsible for generating a visual data curve and downloading an excel report based on data configured in the back end.

Beneficial effects produced by the method provided in embodiments of this application include:

With development of a service, a service of a subway transportation scenario is to generate a large amount of unpredictable data, and the unpredictable data is sent to a back end by different data generators. Therefore, the back end needs to carry out additional development work to manage and control relevant data in real time. In a conventional method, it is inevitable that a dashboard for visualizing data streams includes redundant data and expired data. In addition, due to the different levels of service understanding of product developers, the data stream dashboard developed by the developer does not express a most comprehensive data stream situation, for example, whether there is a correlation between a plurality of data streams and whether there is a deep relationship between a plurality of observation entities. According to the method provided in this application, a higher-quality data source entity relationship and data stream relationship that express impacts hidden in multi-layer relationships between a plurality of entities can be generated a more accurate impact parameter can be acquired based on past experience with a data source entity, that is, a domain model diagram of a service system, a manually annotated impact parameter of known data source entities, and the like. In addition, in combination with a dashboard for visualizing data streams low-code generation platform, a higher-quality data stream dashboard can be provided for service development, labor costs are reduced, redundant data is reduced, the maintainability of the data stream dashboard is improved, service exploration is empowered more effectively, quality of the data stream dashboard is effectively improved, and the higher-quality and more accurate data stream dashboard is provided.

Although operations in flowcharts described in the foregoing embodiments are displayed in sequence according to indications of arrows, these operations are not necessarily performed in sequence according to a sequence indicated by the arrows. Unless otherwise explicitly specified in this application, execution of the operations is not strictly limited, and the operations may be performed in other sequences. Moreover, at least some of the operations in the flowcharts in the above embodiments may include a plurality of operations or stages. The operations or stages are not necessarily performed at the same moment but may be performed at different moments. Execution of the operations or stages is not necessarily performed in sequence, but may be performed alternately with other operations or at least some of operations or stages of other operations.

Based on the same concept, an embodiment of this application further provides an apparatus for implementing the foregoing method for generating a dashboard for visualizing data streams. An implementation for resolving problems provided in the apparatus is similar to the implementation described in the foregoing method. Therefore, for specific limitations of the following one or more apparatus for generating a dashboard for visualizing data streams embodiments, reference may be made to the foregoing limitations to the method for generating a dashboard for visualizing data streams, which is not limited herein.

In one embodiment, as shown in FIG. 11, a apparatus for generating a dashboard for visualizing data streams is provided, including: an acquisition module 1102, a determining module 1104, and a generating module 1106.

The acquisition module 1102 is configured to acquire a domain model diagram of a service system and at least two data sources.

The determining module 1104 is configured to determine relationship data among all domain entities in the domain model diagram based on a first representation vector of the domain model diagram, and determine a data source entity relationship and data stream relationship between the at least two data sources and impact factors of the at least two data sources based on the relationship data and the at least two data sources.

The generating module 1106 is configured to generate a dashboard for visualizing data streams of the service system based on the data source entity relationship, the data stream relationship, and the impact factors.

In one embodiment, the apparatus further includes: a processing module, configured to perform vectorization processing on the domain model diagram to acquire the first representation vector of the domain model diagram. The determining module is further configured to determine relationship data between a target domain entity and a combination of other domain entities in the domain model diagram based on the first representation vector; or determine the relationship data among all the domain entities in the domain model diagram based on the first representation vector.

In one embodiment, the apparatus further includes: a selection module and an aggregation module. The acquisition module is further configured to acquire original data corresponding to the at least two data sources. The selection module is configured to select target data in the original data. The aggregation module is configured to aggregate the data source entity relationship and data stream relationship between the at least two data sources and the impact factors of the at least two data sources with the target data to acquire first aggregated data. The generating module is further configured to generate the data stream dashboard of the service system based on the first aggregated data.

In one embodiment, the acquisition module is further configured to acquire original data corresponding to the at least two data sources. The aggregation module is configured to aggregate the data source entity relationship and data stream relationship between the at least two data sources and the impact factors of the at least two data sources with the original data to acquire second aggregated data. The generating module is further configured to generate the data stream dashboard of the service system based on the second aggregated data.

In one embodiment, the generating module is further configured to use aggregated data as configuration data of a platform back end, so that a platform front end generates the data stream dashboard of the service system based on the configuration data, the aggregated data being the first aggregated data or the second aggregated data, and the platform back end and the platform front end being a back end and front end of a platform of the data stream dashboard respectively.

In one embodiment, the apparatus further includes: a display module, configured to display the data stream dashboard via the platform front end, the data stream dashboard including a visual data chart and a download button. The processing module is further configured to download the visual data chart in response to a triggering operation on the download button, or export the data stream dashboard.

In one embodiment, the processing module is further configured to process the relationship data and identification information of the at least two data sources by using a deep neural network model to acquire the data source entity relationship between and the impact factors of the at least two data sources; and the determining module is further configured to determine the data stream relationship between the at least two data sources based on the data source entity relationship between and the impact factors of the at least two data sources, and the original data corresponding to the at least two data sources.

In one embodiment, the acquisition module is further configured to acquire initial impact factors of the at least two data sources; and the processing module is further configured to process the relationship data, the at least two data sources, and the initial impact factors of the at least two data sources by using the deep neural network model, to acquire the data source entity relationship between and the impact factors of the at least two data sources.

In one embodiment, the selection module is further configured to select a target impact factor meeting a threshold condition from the impact factors; and the acquisition module is further configured to acquire a data source entity relationship corresponding to the target impact factor, and use the data source entity relationship as a target data source entity relationship.

In one embodiment, the data source entity relationship and the impact factors are acquired by processing, by using the deep neural network model, the relationship data and the at least two data sources. The apparatus further includes: a configuration module and a training module. The acquisition module is further configured to acquire a data source entity sample and convert the data source entity sample into vector data. The aggregation module is further configured to perform data aggregation on all pieces of vector data based on different dimensions to acquire aggregated vector data. The configuration module is configured to configure a relationship between at least two pieces of the aggregated vector data to acquire a relationship data sample. The training module is configured to train the deep neural network model based on the aggregated vector data and the relationship data sample.

In one embodiment, the acquisition module is further configured to acquire domain model diagram samples of at least two service systems; the determining module is further configured to determine entity relationship data among all domain entities in each domain model diagram sample based on a second representation vector of the domain model diagram sample; and the configuration module is further configured to configure the relationship between at least two pieces of the aggregated vector data based on the entity relationship data to acquire the relationship data sample.

In one embodiment, each domain entity in the domain model diagram includes an entity for representing a non-data source and an entity for representing a data source; and the determining module is further configured to determine, based on the first representation vector of the domain model diagram, relationship data between entities for representing the data source in the domain model diagram.

All or some of the modules in the foregoing apparatus for generating a dashboard for visualizing data streams may be implemented by software, hardware, and a combination thereof. The modules may be embedded in or independent of a processor in a computer device in the form of hardware, and may alternatively be stored in a memory in the computer device in the form of software, so that the processor may call and perform operations corresponding to each module.

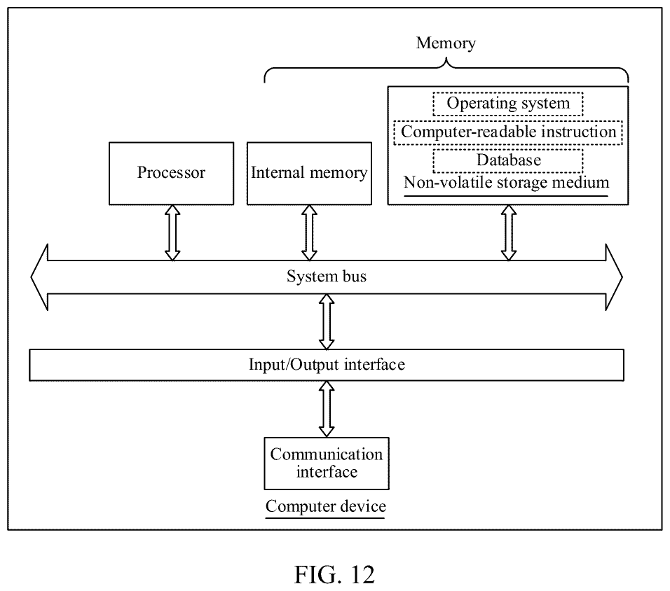

In one embodiment, a computer device is provided. The computer device may be a server, and an internal structure diagram of the computer device may be shown in FIG. 12. The computer device includes a processor, a memory, an input/output interface (I/O for short), and a communication interface. The processor, the memory, and the input/output interface are connected via a system bus, and the communication interface is connected to the system bus via the input/output interface. The processor of the computer device is configured to provide computation and control abilities. The memory of the computer device includes a non-volatile storage medium and an internal memory. The non-volatile storage medium has an operating system, computer-readable instructions, and a database stored thereon. The internal memory provides a running environment for the operating system and the computer-readable instructions on the non-volatile storage medium. The database of the computer device is configured to store generated data of a dashboard for visualizing data streams. The input/output interface of the computer device is configured for information exchange between the processor and an external device. The communication interface of the computer device is configured to communicate with an external terminal. The computer-readable instructions, when executed by the processor, implement a method for generating a dashboard for visualizing data streams.

A person skilled in the art may understand that, the structure shown in FIG. 12 is merely a block diagram of a partial structure related to a solution in this application, and does not constitute a limitation to the computer device to which the solution in this application is applied. Specifically, the computer device may include more components or fewer components than those shown in the figure, or some components may be combined, or a different component deployment may be used.

In one embodiment, a computer device is further provided, including a memory and a processor. The memory has computer-readable instructions stored therein, and the processor implements operations in the foregoing method embodiments when executing the computer-readable instructions.

In one embodiment, a computer-readable storage medium is provided, having computer-readable instructions stored thereon. When being executed by a processor, the computer-readable instructions implement operations in the foregoing method embodiments.

In one embodiment, a computer program product or computer-readable instructions are provided. The computer program product or the computer-readable instructions include computer instructions. The computer instructions are stored in a computer-readable storage medium. A processor of a computer device reads the computer instructions from the computer-readable storage medium, and the processor executes the computer instructions, so that the computer device performs the operations in the above method embodiments.

User information (including but not limited to user equipment information, user personal information, and the like) and data (including but not limited to data configured for analysis, stored data, displayed data, and the like) involved in this application are all information and data authorized by the user or fully authorized by all parties, and collection, use, and processing of relevant data need to comply with relevant laws, regulations, and standards of relevant countries and regions.

A person of ordinary skill in the art may understand that all or some of procedures of the method in the foregoing embodiments may be implemented by instructing relevant hardware by using computer-readable instructions. The computer-readable instructions may be stored in a non-volatile computer-readable storage medium. When the computer-readable instructions are executed, the processes of embodiments of the methods may be included. References to the memory, the database, or another medium used in embodiments provided in this application may all include at least one of a non-volatile or a volatile memory. The non-volatile memory may include a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a grapheme memory, and the like. The volatile memory may include a random access memory (RAM), an external cache memory, or the like. As an illustration and not a limitation, the RAM may be in various forms, for example, a static random access memory (SRAM) or a dynamic random access memory (DRAM). The databases in embodiments of this application may include at least one of a relational database and a non-relational database. The non-relational database may include a blockchain-based distributed database and the like, which is not limited thereto. The processors in embodiments of this application may be a general-purpose processor, a central processing unit, a graphics processing unit, a digital signal processor, a programmable logic device, a data processing logic device based on quantum computing, or the like, which is not limited thereto.

Technical features of the foregoing embodiments may be randomly combined. To make description concise, not all possible combinations of the technical features in the foregoing embodiments are described. However, the combinations of these technical features shall be considered as falling within the scope recorded by this specification provided that no conflict exists.

The foregoing embodiments show only several implementations of this application and are described in detail, which, however, are not to be construed as a limitation to the patent scope of this application. For a person of ordinary skill in the art, several transformations and improvements can be made without departing from the idea of this application. These transformations and improvements belong to the protection scope of this application. Therefore, the protection scope of this application shall be subject to the appended claims.

What is claimed is:

1. A method for generating a dashboard for visualizing data streams, performed by a computer device, the method comprising:
acquiring a domain model diagram of a service system and at least two data sources;
determining relationship data among all domain entities in the domain model diagram based on a first representation vector of the domain model diagram;
determining a data source entity relationship, a data stream relationship, and impact factors of the at least two data sources based on the relationship data and the at least two data sources; and
generating a dashboard for visualizing data streams of the service system based on the data source entity relationship, the data stream relationship, and the impact factors.

2. The method according to claim 1, wherein the method further comprises:
performing vectorization processing on the domain model diagram to acquire the first representation vector of the domain model diagram; and
the determining relationship data among all domain entities in the domain model diagram based on a first representation vector of the domain model diagram comprises:
determining relationship data between a target domain entity and a combination of other domain entities in the domain model diagram based on the first representation vector; or
determining the relationship data among all the domain entities in the domain model diagram based on the first representation vector.

3. The method according to claim 1, wherein the method further comprises:
acquiring original data corresponding to the at least two data sources; and
selecting target data in the original data, and aggregating the data source entity relationship and data stream relationship between the at least two data sources and the impact factors of the at least two data sources with the target data to acquire first aggregated data; and
the generating a dashboard for visualizing data streams of the service system based on the data source entity relationship, the data stream relationship, and the impact factors comprises:
generating the data stream dashboard of the service system based on the first aggregated data.

4. The method according to claim 1, wherein the method further comprises:
acquiring original data corresponding to the at least two data sources; and
aggregating the data source entity relationship and data stream relationship between the at least two data sources and the impact factors of the at least two data sources with the original data to acquire second aggregated data; and
the generating a dashboard for visualizing data streams of the service system based on the data source entity relationship, the data stream relationship, and the impact factors comprises:
generating the data stream dashboard of the service system based on the second aggregated data.

5. The method according to claim 1, wherein the generating a dashboard for visualizing data streams of the service system based on the data source entity relationship, the data stream relationship, and the impact factors comprises:
using aggregated data as configuration data of a platform back end, so that a platform front end generates the data stream dashboard of the service system based on the configuration data, the aggregated data being the first aggregated data or the second aggregated data, and the platform back end and the platform front end being a back end and front end of a platform of the data stream dashboard respectively.

6. The method according to claim 5, wherein the method further comprises:
displaying the data stream dashboard via the platform front end, the data stream dashboard comprising a visual data chart and a download button; and
downloading the visual data chart in response to a triggering operation on the download button, or exporting the data stream dashboard.

7. The method according to claim 1, wherein the determining a data source entity relationship and data stream relationship between the at least two data sources and impact factors of the at least two data sources based on the relationship data and the at least two data sources comprises:
processing the relationship data and identification information of the at least two data sources by using a deep neural network model to acquire the data source entity relationship between and the impact factors of the at least two data sources; and
determining the data stream relationship between the at least two data sources based on the data source entity relationship between and the impact factors of the at least two data sources, and the original data corresponding to the at least two data sources.

8. The method according to claim 7, wherein the processing the relationship data and identification information of the at least two data sources by using a deep neural network model to acquire the data source entity relationship between and the impact factors of the at least two data sources comprises:
acquiring initial impact factors of the at least two data sources; and
processing the relationship data, the at least two data sources, and the initial impact factors of the at least two data sources by using the deep neural network model, to acquire the data source entity relationship between and the impact factors of the at least two data sources.

9. The method according to claim 8, wherein the method further comprises:
selecting a target impact factor meeting a threshold condition from the impact factors; and
acquiring a data source entity relationship corresponding to the target impact factor, and using the data source entity relationship as a target data source entity relationship.

10. The method according to claim 1, wherein the data source entity relationship and the impact factors are acquired by processing, by using the deep neural network model, the relationship data and the at least two data sources; and the method further comprises:
acquiring a data source entity sample and converting the data source entity sample into vector data;
performing data aggregation on all pieces of vector data based on different dimensions to acquire aggregated vector data;
configuring a relationship between at least two pieces of the aggregated vector data to acquire a relationship data sample; and
training the deep neural network model based on the aggregated vector data and the relationship data sample.

11. The method according to claim 10, wherein the configuring a relationship between at least two pieces of the aggregated vector data to acquire a relationship data sample comprises:
acquiring domain model diagram samples of at least two service systems;
determining entity relationship data among all domain entities in each domain model diagram sample based on a second representation vector of the domain model diagram sample; and
configuring the relationship between at least two pieces of the aggregated vector data based on the entity relationship data to acquire the relationship data sample.

12. The method according to claim 1, wherein each domain entity in the domain model diagram comprises an entity for representing a non-data source and an entity for representing a data source; and
the determining relationship data among all domain entities in the domain model diagram based on a first representation vector of the domain model diagram comprises:
determining, based on the first representation vector of the domain model diagram, relationship data between entities for representing the data source in the domain model diagram.

13. A computer device, comprising a memory and one or more processors, the memory having computer-readable instructions stored therein, and the one or more processors, when executing the computer-readable instructions, implementing operations of:
acquiring a domain model diagram of a service system and at least two data sources;
determining relationship data among all domain entities in the domain model diagram based on a first representation vector of the domain model diagram;
determining a data source entity relationship, a data stream relationship, and impact factors of the at least two data sources based on the relationship data and the at least two data sources; and
generating a dashboard for visualizing data streams of the service system based on the data source entity relationship, the data stream relationship, and the impact factors.

14. The computer device according to claim 13, wherein the method further comprises:
performing vectorization processing on the domain model diagram to acquire the first representation vector of the domain model diagram; and
the determining relationship data among all domain entities in the domain model diagram based on a first representation vector of the domain model diagram comprises:
determining relationship data between a target domain entity and a combination of other domain entities in the domain model diagram based on the first representation vector; or
determining the relationship data among all the domain entities in the domain model diagram based on the first representation vector.

15. The computer device according to claim 13, wherein the method further comprises:
acquiring original data corresponding to the at least two data sources; and
selecting target data in the original data, and aggregating the data source entity relationship and data stream relationship between the at least two data sources and the impact factors of the at least two data sources with the target data to acquire first aggregated data; and
the generating a dashboard for visualizing data streams of the service system based on the data source entity relationship, the data stream relationship, and the impact factors comprises:
generating the data stream dashboard of the service system based on the first aggregated data.

16. The computer device according to claim 13, wherein the method further comprises:
acquiring original data corresponding to the at least two data sources; and
aggregating the data source entity relationship and data stream relationship between the at least two data sources and the impact factors of the at least two data sources with the original data to acquire second aggregated data; and
the generating a dashboard for visualizing data streams of the service system based on the data source entity relationship, the data stream relationship, and the impact factors comprises:
generating the data stream dashboard of the service system based on the second aggregated data.

17. The computer device according to claim 13, wherein the generating a dashboard for visualizing data streams of the service system based on the data source entity relationship, the data stream relationship, and the impact factors comprises:
using aggregated data as configuration data of a platform back end, so that a platform front end generates the data stream dashboard of the service system based on the configuration data, the aggregated data being the first aggregated data or the second aggregated data, and the platform back end and the platform front end being a back end and front end of a platform of the data stream dashboard respectively.

18. The computer device according to claim 17, wherein the method further comprises:
displaying the data stream dashboard via the platform front end, the data stream dashboard comprising a visual data chart and a download button; and
downloading the visual data chart in response to a triggering operation on the download button, or exporting the data stream dashboard.

19. The computer device according to claim 13, wherein the determining a data source entity relationship and data stream relationship between the at least two data sources and impact factors of the at least two data sources based on the relationship data and the at least two data sources comprises:
processing the relationship data and identification information of the at least two data sources by using a deep neural network model to acquire the data source entity relationship between and the impact factors of the at least two data sources; and
determining the data stream relationship between the at least two data sources based on the data source entity relationship between and the impact factors of the at least two data sources, and the original data corresponding to the at least two data sources.

20. One or more non-transitory computer storage media having computer-readable instructions stored thereon, the computer-readable instructions, when executed by one or more processors, implementing
acquiring a domain model diagram of a service system and at least two data sources;
determining relationship data among all domain entities in the domain model diagram based on a first representation vector of the domain model diagram;
determining a data source entity relationship, a data stream relationship, and impact factors of the at least two data sources based on the relationship data and the at least two data sources; and
generating a dashboard for visualizing data streams of the service system based on the data source entity relationship, the data stream relationship, and the impact factors.
